(19) United States
(12) Patent Application Publication
(10) Pub. No.: US 2026/0195643 A1
(43) Pub. Date: Jul. 9, 2026

(54) Forward-Forward Training for Machine Learning

(71) Applicant: Google LLC, Mountain View, CA (US)

(72) Inventor: Geoffrey Everest Hinton, Toronto (CA)

(21) Appl. No.: 19/132,154

(22) PCT Filed: Nov. 22, 2023
(86) PCT No.: PCT/US2023/080910

§ 371 Date: May 22, 2025

Related U.S. Application Data
(60) Provisional application No. 63/427,332, filed on Nov. 22, 2022.

(51) Int. Cl. G06N 20/00

(52) U.S. Cl. CPC G06N 20/00

(57) ABSTRACT

Example implementations provide a computer-implemented method for training a machine-learned model, the method comprising: processing, using a layer of the machine-learned model, positive input data in a first forward pass; updating one or more weights of the layer to adjust, in a first direction, a goodness metric of the layer for the first forward pass; processing, using the layer, negative input data in a second forward pass; and updating the one or more weights to adjust, in a second direction, the goodness metric of the layer for the second forward pass.

### PRIORITY

The present application claims priority to and the benefit of U.S. Provisional Patent Application No. 63/427,332 (filed Nov. 22, 2022). U.S. Provisional Patent Application No. 63/427,332 is hereby incorporated by reference herein in its entirety.

### SUMMARY

Aspects and advantages of embodiments of the present disclosure will be set forth in part in the following description, including the appendix, or can be learned from the description, or can be learned through practice of the embodiments.

In an aspect, the present disclosure provides an example method for training a machine-learned model. The example method can include processing, using a layer of the machine-learned model, positive input data in a first forward pass. The example method can include updating one or more weights of the layer to adjust, in a first direction, a goodness metric of the layer for the first forward pass. The example method can include processing, using the layer, negative input data in a second forward pass. The example method can include updating the one or more weights to adjust, in a second direction, the goodness metric of the layer for the second forward pass.

In some implementations of the example method, the negative input data is generated using the machine-learned model.

In some implementations of the example method, the positive input data includes image data, and wherein the negative input data is generated by masking the positive input data.

In some implementations of the example method, the negative input data includes a contrastive example to the positive input data.

In some implementations of the example method, the example method includes, for each respective forward pass, postprocessing the output of the layer to obscure, from a subsequent layer, the goodness metric of the layer.

In some implementations of the example method, the postprocessing includes normalizing the output of the layer.

In some implementations of the example method, the goodness metric is a local goodness metric for evaluating the layer.

In some implementations of the example method, the goodness metric is based on the activations in the layer.

In some implementations of the example method, updating the weights to adjust the goodness metric in the first direction includes updating the weights to increase activations in the layer for positive input data.

In some implementations of the example method, updating the weights to adjust the goodness metric in the second direction includes updating the weights to decrease activations in the layer for negative input data.

In some implementations of the example method, the positive input data includes a ground truth label and the negative input data comprises an incorrect label.

In some implementations of the example method, the example method includes processing a test input with a neutral label; computing a softmax over activations within one or more layers of the machine-learned model; and returning an output of the machine-learned model based on an output of the softmax.

In some implementations of the example method, the output of the softmax is a prediction output.

In some implementations of the example method, the neutral label includes a uniform distribution over prediction classes.

In some implementations of the example method, the positive input data includes image data.

In some implementations of the example method, the machine-learned model includes a non-differentiable component.

In some implementations of the example method, the layer receives a top-down input from another layer ordered subsequent to the layer.

In some implementations of the example method, the layer receives a top-down input associated with a prior forward pass.

In some implementations of the example method, the machine-learned model includes a fast training loop and a slow training loop, wherein the layer is in the fast training loop and the slow training loop includes one or more other machine-learned components, wherein the slow training loop operates over a longer time scale than the fast training loop.

In an aspect, the present disclosure provides an example one or more non-transitory computer-readable media storing instructions that are executable by one or more processors to perform operations, the operations comprising one or more implementations of the example method.

In an aspect, the present disclosure provides an example computing system having one or more processors and one or more non-transitory computer-readable media storing instructions that are executable by the one or more processors to cause the computing system to perform operations, the operations including one or more implementations of the example method.

In an aspect, the present disclosure provides an example computing system including an electrical circuit implementing an analog neural network trained according to one or more implementations of the example method.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A is a block diagram of an example system for implementing forward-forward training according to example implementations of aspects of the present disclosure;

FIG. 1B is a block diagram of an example system for implementing forward-forward training according to example implementations of aspects of the present disclosure;

FIG. 2 is an illustration of a technique for generating negative inputs for implementing forward-forward training according to example implementations of aspects of the present disclosure;

FIG. 3 is a block diagram of an example system for implementing forward-forward training according to example implementations of aspects of the present disclosure;

FIG. 4 is a block diagram of an example system for implementing forward-forward training according to example implementations of aspects of the present disclosure;

FIG. 5 is a flow chart diagram illustrating an example method for training a machine-learned model according to example implementations of aspects of the present disclosure;

FIG. 6 is a block diagram of an example processing flow for using machine-learned model(s) to process input(s) to generate output(s) according to example implementations of aspects of the present disclosure;

FIG. 7 is a block diagram of an example model development platform according to example implementations of aspects of the present disclosure;

FIG. 8 is a block diagram of an example training workflow for training a machine-learned model according to example implementations of aspects of the present disclosure;

FIG. 9 is a block diagram of an inference system for operating one or more machine-learned model(s) to perform inference according to example implementations of aspects of the present disclosure;

FIG. 10 is a block diagram of an example networked computing system according to example implementations of aspects of the present disclosure;

FIG. 11 is a block diagram of an example computing device according to example implementations of aspects of the present disclosure; and

FIG. 12 is a block diagram of an example computing device according to example implementations of aspects of the present disclosure.

### DETAILED DESCRIPTION

Example aspects of the present disclosure generally relate to training machine-learned models. Advantageously, example implementations can train machine-learned models using contrastive learning between forward passes based on efficiently computed goodness metrics. For instance, a per-layer goodness metric can be computed for updating the weights of layer(s) of a machine-learned model. When processing positive examples, the weight update can be configured to adjust the goodness metric in a first direction. When processing negative examples, the weight update can be configured to adjust the goodness metric in a second direction. In this manner, for example, the layers of the model can be updated using multiple forward passes.

Traditionally, a common technique for updating machine-learned models uses backpropagation of gradients from the output of the model to the input of the model. In this manner, by propagating the gradients through the model, the weights in internal layers of the model can be updated based on their effects on the model output. This can involve costly computation in some instances. And in some scenarios, backpropagation may not be possible due to limited knowledge of the model structure or a lack of differentiable components through which to pass the gradients.

A traditional alternative to backpropagation is reinforcement learning. But reinforcement learning procedures can suffer from high variance: it can be hard to see the effect of perturbing one variable when many other variables are being perturbed at the same time. Thus, in some scenarios, reinforcement learning scales badly and does not always compete with backpropagation for large networks containing millions or billions of parameters.

Advantageously, example techniques described herein can train machine-learned models efficiently in a scalable manner, optionally without backpropagating gradients through the model end-to-end. Example implementations can leverage a local goodness function for updating layer weights locally. In some implementations this obviates the need to backpropagate gradients from the output to the layer. Example implementations also have the advantage of learning while pipelining sequential data through a neural network without ever storing the neural activities or stopping to propagate error derivatives.

More particularly, example implementations of the present disclosure can include a multi-layer learning procedure. Example implementations can, in lieu of the forward and backward passes of backpropagation, execute two forward passes that operate in the same way as each other, but on different data and with opposite objectives. In general, the aim of the learning can be to make some goodness metric be above some threshold value for “real data” and below that value for “negative data.”

The positive forward pass can operate on real data and adjust the weights to increase the goodness in one or more hidden layers. The negative forward pass can operate on “negative data” and adjust the weights to decrease the goodness in one or more hidden layers. Example measures of goodness include the sum of the squared neural activities (e.g., the sum of the squares of the activities of the rectified linear neurons in a layer). This goodness can be used to, for instance, estimate a probability that an input vector is positive (“real”) by applying the logistic function, σ to the goodness, minus some threshold, θ:

$$P ( positive ) = σ ( ( {\sum }_{j} {y}_{j}^{2} ) - θ )$$

where yⱼ is the activity of hidden unit j before layer normalization. The negative data can be predicted by the neural net using top-down connections, or it may be supplied externally. Other goodness metrics can include a negative sum of squared neural activities. Other goodness metrics can include a sum of the neural activities (e.g., not squared).

Forward-forward training can be performed in a supervised or unsupervised manner. One way to use contrastive learning for a supervised learning task is to first learn to transform input vectors into representation vectors without using any information about the labels and then to learn a simple linear transformation of these representation vectors into vectors of logits which are used in a softmax to determine a probability distribution over labels. The learning of the linear transformation to the logits can be supervised but does not involve learning any hidden layers, so it does not require backpropagation of derivatives.

Forward-forward training according to example aspects of the present disclosure can be used to perform this kind of representation learning by using real data vectors as the positive examples and corrupted data vectors as the negative examples. There are many very different ways to corrupt the data. Negative data that has very different long range correlations but very similar short range correlations can cause the model being trained to focus on the longer range correlations. In an image processing example, this can be done by creating a mask containing fairly large regions of ones and zeros. Hybrid images can then be created for the negative data by adding together one digit image times the mask and a different digit image times the reverse of the mask. Masks like this can be created by starting with a random bit image and then repeatedly blurring the image with a filter (e.g., a filter of the form [¼, ½, ¼]) in both the horizontal and vertical directions. After repeated blurring, the image can then be thresholded at 0.5.

Supervised learning can be implemented by including the label in the input. In an image processing example, the positive data can include an image with the correct label and the negative data can include the image with the incorrect label. In an example, the only difference between positive and negative data is the label. After training, it can be possible to classify an input image by doing a single forward pass through the net starting from an input that consists of the image and a neutral label composed of a uniform distribution over output classes (e.g., classification categories). The hidden activities of one or more layers (e.g., all but the first hidden layer) can then be used as the inputs to a softmax that has been learned during training.

Alternatively, the network can be executed with a particular label as part of the input. The goodnesses of one or more layers (e.g., all but the first) can be accumulated. After doing this for each label separately, the label with the highest accumulated goodness can be selected as the output. During training, a forward pass from a neutral label can be used to pick hard negative labels. This can make the training use fewer epochs (e.g., a third as many).

The training data can be augmented by jittering the images (e.g., by two pixels in each direction).

In an example, parameters of a hidden layer can be learned by making the sum squared activities of the hidden units be high for positive data and low for negative data. In some cases, however, if the activities of the first hidden layer are then used as input to the second hidden layer, it might be trivial for the second hidden layer to “cheat” and distinguish positive from negative data by simply using the length of activity vector in the first hidden layer. To prevent this, and to cause subsequent layers to learn new features, example implementations of the present disclosure can normalize the length of the hidden vector before using it as input to a following layer. In some aspects, this can remove information that was used to determine the goodness in the first hidden layer and force the next hidden layer to infer the positive or negative attribute using information in the relative activities of the neurons in the first hidden layer. These relative activities can be preserved in the layer-normalization. To put it another way, the activity vector in the first hidden layer can have a length and an orientation. The length can be used to define the goodness for that layer. The orientation can be passed to the next layer (e.g., only the orientation).

In an example, forward-forward training can be implemented as a type of generative adversarial network in which every hidden layer of the discriminative network makes its own greedy decision about whether the input is positive or negative so there is no need to backpropagate to learn the discriminative model. In such an example, backpropagation might not be needed to learn the generative model because, instead of learning its own hidden representations, it just reuses the representations learned by the discriminative model. This can free the generative model to focus on learning how to convert those hidden representations into generated data. If this is done using a linear transformation, for example, to compute the logits of a softmax, no backpropagation is required. One advantage of using the same hidden representations for both models is that it can eliminate the problems that arise when one model learns too fast relative to the other model. It also can eliminate mode collapse.

In an example, forward-forward training can operate on networks that include unknown “black box” components. The black box can apply an unknown and possibly stochastic transformation to the output of one layer and presents this transformed activity vector as the input to the next layer. This does not disturb or prevent the local learning within each layer.

In an example, the black boxes can be or include machine-learned components (e.g., neural nets with a few hidden layers). If these machine-learned components learn slowly with respect to the non-black box components (e.g., the “outer loop”), then the “outer loop” forward-forward learning can quickly adapt to new data under the assumption that the black boxes are stationary. Slow learning in the black boxes can then improve the system over a much longer timescale. For example, a slow reinforcement learning procedure could add small random noise vectors to the inputs to neurons inside the black box and then multiply these activity perturbation vectors by the change in the cost function used by the positive phase of the forward-forward training system to get a noisy but unbiased estimate of the derivative of the forward-forward cost function with respect to the activities of neurons inside the black box.

In an example, the vector of increments of the incoming weights for hidden neuron j is given by

$$Δ {w}_{j} = 2 ϵ \frac{\partial log ( p )}{\partial {\sum }_{j} {y}_{j}^{2}} {y}_{i} x$$

where yⱼ is the activation (e.g., ReLU output) before layer normalization, wⱼ is the vector of incoming weights of neuron j, and ε is the learning rate.

In an example, a weight update computed for a given input vector x can leave unaffected the layer normalized output for that input vector. This means that it can be possible to perform simultaneous online weight updates in many different layers. For instance, changes in the activity vectors in later layers for a given input vector can be independent of the weight updates in earlier layers. As such, it can be possible to change all the weights in one step so that every layer exactly achieves a desired goodness of S* for input vector x. Assuming that the input vector x and all of the layer-normalized hidden vectors are of length l, the learning rate that achieves this can be expressed as

$$ϵ = \sqrt{\frac{{S}^{*}}{{S}_{L}}} - 1$$

where S_{L} is the current sum of squared activities of layer L before layer normalization.

An energy efficient way to multiply an activity vector by a weight matrix is to implement activities as voltages and weights as conductances. Their products, per unit time, are charges which add themselves. Unfortunately, it is difficult to implement the backpropagation procedure in an equally efficient way. Thus traditional methods use analog to digital converters and digital computations for computing gradients. The use of two forward passes instead of a forward and a backward pass can advantageously permit more efficient analog neural network computations.

For instance, analog machine-learning devices can directly implement neural network pathways for performing forward passes. This can allow large and unknown variations in the connectivity and non-linearities of different instances of hardware that are intended to perform the same task, with reliance on post-manufacture learning procedures to discover parameter values that make effective use of the unknown properties of each particular instance of the hardware. This can make it possible to achieve large savings in the energy required to perform a computation and in the cost of fabricating the hardware that executes the computation. For duplication, the instances can be trained from scratch. Or the instances can receive learning distilled from another instance (e.g., a teacher instance). For example, for a task like classification of objects in images, a function of interest is the function relating pixel intensities to class labels. The function can be transferred (approximately) to a different piece of hardware by using distillation: the new hardware can be trained not only to give the same answers as the old hardware but also to output the same probabilities for incorrect answers. These probabilities can be a much richer indication of how the old model generalizes than just the label it thinks is most likely. So by training the new model to match the probabilities of incorrect answers, distillation can train it to generalize in the same way as the old model.

Example aspects of the present disclosure can provide a number of technical effects and benefits. In some scenarios backpropagation may be computationally prohibitive or impossible due to a lack of model information or a lack of differentiability. Advantageously, example techniques described herein can improve training of machine learned models and thus the machines that implement the machine-learned models. Processing resources can be used more efficiently, and real-time computation and learning can be implemented in constrained computing environments. Thus, example implementations can improve the functioning of computing systems and advance the field of machine learning and machine-learned systems as a whole.

A technical effect of example implementations of the present disclosure is increased energy efficiency in performing operations using machine-learned models, thereby improving the functioning of computers implementing such models. For instance, example implementations can provide for more energy-efficient runtime execution or inference. In some scenarios, increased energy efficiency can provide for less energy to be used to perform a given task (e.g., less energy expended to maintain the model in memory, less energy expended to perform calculations within the model, etc.). In some scenarios, increased energy efficiency can provide for more task(s) to be completed for a given energy budget (e.g., a larger quantity of tasks, more complex tasks, the same task but with more accuracy or precision, etc.).

In another example aspect, example implementations can provide for more energy-efficient training operations or model updates. In some scenarios, increased energy efficiency can provide for less energy to be used to perform a given number of update iterations (e.g., less energy expended to maintain the model in memory, less energy expended to perform calculations within the model, such as computing gradients, backpropagating a loss, etc.). In some scenarios, increased energy efficiency can provide for more update iterations to be completed for a given energy budget (e.g., a larger quantity of iterations, etc.). In some scenarios, greater expressivity afforded by model architectures and training techniques of the present disclosure can provide for a given level of functionality to be obtained in fewer training iterations, thereby expending a smaller energy budget. In some scenarios, greater expressivity afforded by model architectures and training techniques of the present disclosure can provide for an extended level of functionality to be obtained in a given number of training iterations, thereby more efficiently using a given energy budget.

In this manner, for instance, the improved energy efficiency of example implementations of the present disclosure can reduce an amount of pollution or other waste associated with implementing machine-learned models and systems, thereby advancing the field of machine-learning and artificial intelligence as a whole. The amount of pollution can be reduced in toto (e.g., an absolute magnitude thereof) or on a normalized basis (e.g., energy per task, per model size, etc.). For example, an amount of CO2 released (e.g., by a power source) in association with training and execution of machine-learned models can be reduced by implementing more energy-efficient training or inference operations. An amount of heat pollution in an environment (e.g., by the processors/storage locations) can be reduced by implementing more energy-efficient training or inference operations.

Example aspects of the present disclosure are discussed herein in reference to the enclosed figures.

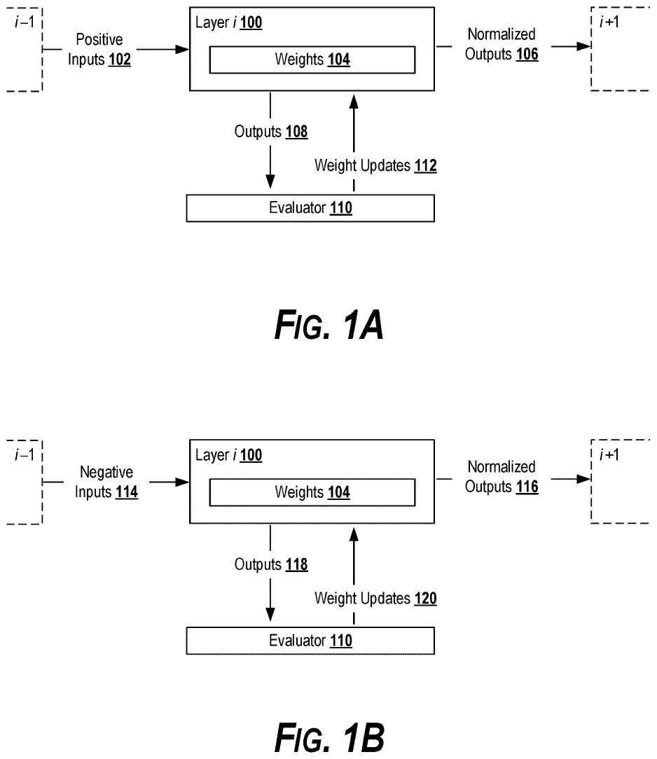

FIG. 1A is a block diagram of an example system for implementing forward-forward training according to example aspects of the present disclosure. In a positive forward pass, a layer 100 of a machine-learned model can process positive inputs 102 using learnable weights 104. Layer 100 can pass outputs 106 to a subsequent layer (e.g., an immediately subsequent layer) for further processing. Outputs 106 can be normalized. Outputs 108 (e.g., non-normalized outputs) can pass to an evaluator 110 which can compute weight updates 112 for updating weights 104.

Layer 100 can be a layer or other subunit of a machine-learned model that processes inputs to generate outputs using one or more learnable weights. Layer 100 can include multiple sub-layers. Layer 100 can be linear or nonlinear. Layer 100 can include one or more neurons of an artificial neural network. Layer 100 can include one or more activation functions (e.g., ReLU and ReLU-based functions, negative log of the density under a t-distribution, sigmoid, tanh, swish, etc.). Layer 100 can include one or more different types of operators. Layer 100 can include a convolutional layer, a fully connected layer, a pooling layer, an attention layer, a normalization layer, a resizing layer, a filtering layer, etc.

Positive inputs 102 can include data that is labeled or otherwise associated with a correct, valid, or desired output of the machine-learned model. For instance, in a classification task, positive inputs 102 can include data items that are correctly labeled with their respective categories. If the task is image recognition, positive inputs 102 can be images that are correctly tagged with their corresponding object or scene identifications. Alternatively, in a regression task, positive inputs 102 can be data items that are paired with their correct numerical outputs. In a generation task, positive inputs 102 can include data items for which a desired generation output is known (e.g., a desired next word, etc.). Positive inputs 102 can include states and actions that are associated with higher rewards or desired outcomes.

Positive inputs 102 can include unlabeled data (e.g., for unsupervised learning). The inputs can be “positive” in that they represent the original content, structure, or distribution of the underlying data from which the inputs were obtained. For example, in clustering tasks, the positive inputs can be data points that belong to the same cluster. In generation tasks, the positive inputs can be words that precede or follow a known generation target that is obtained from the original data (e.g., using masked language modeling or causal language modeling techniques).

Positive inputs 102 can include synthetic or transformed data derived from an original data set. Data augmentation techniques can be used to create additional positive examples by applying transformations such as rotations, translations, scaling, or noise addition to the original positive data points. This can enhance the robustness of the model by providing it with a more diverse set of examples. For example, an image processing context, positive inputs can include images that have undergone transformations such as flipping, scaling, cropping, or color variation. In a language modeling context, positive inputs can include sequence of values obtained from natural language strings having synonyms substituted.

Positive inputs 102 can include a variety of different types of data. Positive inputs 102 can include numeric data, such as measurements or sensor readings, that represent physical quantities like temperature, pressure, speed, or location (e.g., recorded over time). Positive inputs 102 can include text data, such as words or sentences, which could be used for applications like sentiment analysis, language generation, language translation, instruction following, question answering, etc. Positive inputs 102 can include image data, such as pictures or videos. Positive inputs 102 can include audio data. Positive inputs 102 can be sourced from a variety of datasets such as image libraries, text databases, audio files, or other forms of structured and unstructured data. Positive inputs 102 can include real-world examples collected using sensors of a computing device.

Weights 104 can parameterize one or more parts of layer 100. For instance, these weights can influence an output of layer 100 based on a value of an input. Weights 104 can be adjusted during training to shift the output that layer 100 produces in response to specific input data.

Weights 104 can be applied to individual variables or features within the input data. Weights 104 can emphasize the significance or importance of each feature in the decision-making process of layer 100. For example, weights 104 can determine a strength of connections between neurons in an artificial neural network or the coefficients in a linear regression model. For example, weights 104 can include gating weights that cause one or more portions of layer 100 to activate for processing a particular set of inputs. Weights 104 can be associated with edges connecting nodes between two layers and can influence how much the activation of one node affects the input of another node. Weights 104 can correspond to the values of a convolutional kernel applied to input data during a forward pass. Weights 104 can be used for computing attention over an input sequence (e.g., self-attention).

Weights 104 can be represented as numerical values of various bit depths, vectors, matrices, or higher-order tensors. Weights 104 can be constrained to a set of discrete weight values. The set of discrete weight values can correspond to a bit depth in which the weight is stored. The set of discrete weight values can be determined using a quantization technique. The set of discrete weight values can be determined based on one or more hardware constraints of the hardware used to store the value of the weight (e.g., digitally or in analog).

Weights 104 can be initialized randomly or using various different initialization strategies. They can also be pre-trained using other models or techniques.

Outputs 106 can include a value or other signal emitted by layer 100. Outputs 106 can be or represent numerical values that represent the computed results of an operation or function applied by layer 100. These numerical values can be generated using weights 104. The values can be computed using an activation function (e.g., a nonlinear activation function).

Outputs 106 can be normalized. Outputs 106 can be normalized using various different methods to cause the magnitude(s) to be within a predetermined range. Normalization can involve scaling the outputs so that they fall within a certain range, such as between 0 and 1, have a mean of 0 and standard deviation of 1, etc. For instance, min-max normalization can be used. For instance, the smallest value can be transformed to 0, the largest value can be transformed to 1, and all other values can be scaled to lie therebetween (e.g., proportionally). Standard score normalization (Z-score normalization) can also be implemented, where the mean output value is subtracted from each output and the result is divided by the standard deviation of the outputs. A softmax operator can convert the outputs to lie between 0 and 1.

Normalization can maintain the relative relationship between different output vectors, preserving the directional information of the outputs. For instance, a magnitude of output(s) 106 can be scaled while an overall direction or trend in the data can be preserved. In the context of neural networks, this can cause an orientation of the activity vector in a first layer to be preserved when passed on to the next layer, carrying forward the relative activities of the neurons. For example, outputs 106 can be normalized via vector normalization. For instance, the magnitude of the output vector can be calculated and each element of the vector can be divided by this magnitude. This can result in a unit vector that maintains the direction of the original output vector, preserving the relative ratios of the initial values. The mean can be subtracted from the unscaled vector.

Outputs 108 can include a value or other signal emitted by layer 100. Outputs 108 can be or represent numerical values that represent the computed results of an operation or function applied by layer 100. These numerical values can be generated using weights 104. The values can be computed using an activation function (e.g., a nonlinear activation function).

Outputs 108 can be the same as or different from outputs 106. Outputs 108 can be normalized to obtain outputs 106. For example, outputs 108 can be pre-normalization values of outputs 106.

Outputs 108 can indicate or represent raw activity within layer 100. For instance, outputs 108 can represent the calculated output of neurons within an artificial neural network, or the results of an individual operation or function applied by layer 100. These numerical values can be calculated using weights 104 in conjunction with input data 102. The values can be obtained through the application of an activation function, such as a nonlinear activation function like ReLU, sigmoid, or tanh. Outputs 108 can reflect the raw, non-normalized results of these operations, preserving the scale and spread of the values.

Evaluator 110 can be a hardware or software component configured to update values of weights 104 based on outputs 108. Evaluator 110 can compute a goodness metric across one or more inputs and output weight updates 112. For instance, the goodness metric can be an optimization objective, and evaluator 110 can update weights 104 to optimize the goodness metric.

Evaluator 110 can evaluate a local gradient over layer 100 to determine appropriate updates to weights 104 (e.g., to determine how changes to each weight can affect the goodness metric). The gradient can indicate the direction and magnitude of change in the goodness metric for small changes in the weights. Evaluator 110 can then update weights 104 in the direction to improve the goodness metric.

Evaluator 110 can use a zero-order optimization algorithm that does not compute or use gradients. For instance, a random search algorithm can be used that randomly samples different weight values and selects the weight values that give the best performance according to the goodness metric.

Evaluator 110 can implement a rate at which weights 104 are updated. This rate, often referred to as the learning rate, can determine the step size at each iteration of the optimization algorithm. A smaller learning rate can result in smaller updates to the weights. A larger learning rate can result in larger weight updates. Evaluator 110 can adjust the learning rate over time. For example, the learning rate can be initially large to quickly converge to a good solution, and then gradually reduced to refine the weights. This strategy, often referred to as learning rate annealing, can balance the speed and precision of convergence. Alternatively, the learning rate can be adapted based on the progress of learning.

Evaluator 110 can implement regularization during training. Regularization can include adding a penalty term to the objective. For instance, a penalty term can be a function of the magnitudes of the weights, such as their sum or sum of squares. During training, evaluator 110 can balance the goodness metric and the penalty term (e.g., using a weighted combination thereof for an objective).

Weight updates 112 can include updates to the values of weights 104. These updates can be determined based on the computed goodness metric from evaluator 110. Weight updates 112 can be in the form of incremental adjustments to the current values of the weights. Weight updates 112 can be influenced by a learning rate, which can control the scale of the updates. For instance, a smaller learning rate can result in smaller adjustments to the weights, while a larger learning rate can result in larger adjustments. The learning rate can be constant or it can vary over time or across different layers.

FIG. 1B is a block diagram of an example system for implementing forward-forward training according to example aspects of the present disclosure. In a negative forward pass, a layer 100 of a machine-learned model can process negative inputs 114 using learnable weights 104. Layer 100 can pass normalized outputs 116 to a subsequent layer (e.g., an immediately subsequent layer) for further processing. Outputs 118 (e.g., non-normalized outputs) can pass to evaluator 110 which can compute weight updates 120 for updating weights 104.

Negative inputs 114 can include data selected to provide contrast against positive inputs 102. For example, while positive inputs 102 can include data selected to demonstrate desired model behavior, negative inputs 114 can be selected to demonstrate a boundary of that desired model behavior (e.g., a decision boundary) such that the machine-learned model can distinguish between positive inputs 102 and negative inputs 114.

For instance, for a classification task, negative inputs 114 can include data items that are labeled incorrectly or associated with an undesired output. For an image recognition task, negative inputs 114 can include images that are paired with incorrect object or scene identifications. For a regression task, negative inputs 114 can include data items that are paired with incorrect numerical outputs.

Negative inputs 114 can also be artificially generated or altered from the original data. For example, for an image processing task, negative inputs 114 can include images that have been distorted, inverted, or had noise added to them. For a language modeling task, negative inputs 114 can include sequences of words in which the order has been randomly shuffled, or sequences in which one or more words have been replaced by random words. For a prediction task, negative inputs 114 can include random or uncorrelated inputs.

Negative inputs 114 can be obtained using the machine-learned model itself. For example, a performance of the model can guide selection of negative inputs 114 that probe weaknesses in the decision boundary of the model. For example, an input processed by the model in a prior pass can inform selection of negative inputs 114.

For example, a neural network configured to classify an input over a plurality of classes can process an input classification vector that has a value associated with each output class. At runtime, the input classification vector can be processed by the model and updated to obtain a probability distribution over the output classes. During training, however, the probability distribution over the output classes can be used to select a “hard” negative training example. For instance, an input can be known to be associated with a first class. The input can be ingested by the model with a neutral classification vector (e.g., a uniform distribution over output classes). The output probability distribution can include a highest probability for the first class and a second-highest probability for a second class. A negative example can be generated by combining the same input with an input classification vector that biases the probability toward the second class (e.g., a one-hot vector on the second class). In this manner, for instance, the negative example can indicate an error that presents the toughest challenge for the model, with an error that the model is already inclined to make with respect to the input. By training the model, then, to avoid producing the negative example, the model can learn to distinguish inputs in the hard cases.

Negative inputs 114 can be generated using the machine-learned model itself or a different machine-learned model. For example, a generative machine-learned model can generate images, text, or other synthetic data that can provide negative inputs. The generative machine-learned model can be optimized to generate examples that are useful for training. For example, the generative machine-learned model can receive one or more inputs describing a subject machine-learned model (e.g., a current performance, a current output, such as a latent distribution of logits indicating reasoning over an output space) and generate a negative example that, when used to train the subject machine-learned model as described herein, can result in a maximum or significant improvement. For example, the generative machine-learned model can be trained to generate hard negative examples.

Negative inputs 114 can be obtained from external sources or datasets. For instance, in a real-world application, negative inputs 114 can include outlier data or error cases collected from runtime implementations. These could be instances where the system or model has previously failed or made an error. Negative inputs 114 can be sampled from a different distribution than positive inputs 102, helping the model to learn the boundary between the two.

Outputs 116 can be the same type of data or different from outputs 106. Outputs 118 can be the same type of data or different from outputs 108.

Evaluator 110 can process outputs 118 to evaluate a performance of layer 110. Evaluator 110 can evaluate the performance of layer 100 by processing outputs 118 using a goodness metric. The goodness metric can include an objective value for optimizing layer 100.

The goodness metric can be configured to have a value tending in one direction for positive inputs 102 and tending in another direction for negative inputs 114. For example, a goodness metric can increase in value for positive inputs 102 and decrease in value for negative inputs 114. In this manner, for instance, evaluator 110 can be configured to update layer 100 such that positive inputs 102 cause layer 100 to be characterized by a goodness metric above a threshold value while negative inputs 114 cause layer 100 to be characterized by a goodness metric below a threshold value. In this manner, for instance, a value of a goodness metric can correspond to how well a layer 100 distinguishes between positive inputs 102 and negative inputs 114. In this manner, for instance, evaluator 110 can update weights 104 with weight updates 120 weight updates 120 to increase a difference between outputs 108 and outputs 118 (or outputs 106 and outputs 116).

In an example, evaluator 110 can be configured to update weights 104 to cause the goodness metric to be above some threshold value for positive inputs 102 and below that value for negative inputs 114. For example, weight updates 112 can adjust weights 104 to increase the goodness metric over layer 100 evaluated for positive inputs 102. Weight updates 120 can adjust weights 104 to decrease the goodness metric over layer 100 evaluated for negative inputs 114.

Example measures of goodness include the sum of the squared neural activities (e.g., the sum of the squares of the activities of the rectified linear neurons in a layer). This goodness metric can be used to, for instance, estimate a probability that an input vector is positive by applying the logistic function, σ to the goodness, minus some threshold, θ:

$$P ( positive ) = σ ( ( {\sum }_{j} {y}_{j}^{2} ) - θ )$$

where yⱼ is the activity of hidden unit j before layer normalization. Other goodness metrics can include a negative sum of squared neural activities.

$$P ( positive ) = σ ( θ - {\sum }_{j} {y}_{j}^{2} )$$

Other goodness metrics can include a sum of the neural activities (e.g., not squared).

Example goodness metrics can operate over one or more feature detectors. For example, layers or portions of a layer can be configured for detecting features in an input that correlate to a desired output. These portions can be trained using an objective that correlates to the desired behavior (e.g., maximizing sum of activations if feature detector should be activated, minimizing sum if feature detector should not be activated). For example, layers or portions of a layer can be configured for detecting or enforcing constraints. For example, these portions can be trained using an objective that correlates to the desired behavior (e.g., maximizing sum of activations if constraint detector should be activated, minimizing sum if constraint detector should not be activated). Such various portions can work in tandem. An objective can include a first goodness metric that evaluates performance of a feature detector portion and a second goodness metric that evaluates a performance of a constraint detector portion. Evaluator 110 can update weights of the feature detector portion to increase its feature detecting performance (e.g., increase or decrease a number of activations on a detected feature). Evaluator 110 can update weights of the constraint detector portion to increase its constraint detecting performance (e.g., increase or decrease a number of activations on a detected constraint).

In an example, different goodness metrics can be used for layers (or processing units within layers) that correspond to different portions of an input. For example, different portions of an input can encode different information that can be processed differently by a machine-learned model. Using multiple different goodness functions can allow improved learning of the model.

Goodness metrics can be searched as a hyperparameter in a neural architecture search space. For example, a neural architecture search space can facilitate identification of optimal goodness metrics. Goodness metrics can be parameterized with one or more learnable parameters. These learnable parameters can be updated in an outer training loop to optimize a performance of the model.

In an example, weights 104 can be learned by making the sum squared activities of the hidden units in layer 100 be high for positive inputs 102 and low for negative inputs 114. In some cases, however, if the activities of the first hidden layer are then used as input to the second hidden layer, it might be trivial for the second hidden layer (e.g., layer i+1) to “cheat” and distinguish positive from negative data by simply using the length of activity vector in the first hidden layer. To prevent this, and to cause subsequent layers to learn new features, example implementations of the present disclosure can normalize outputs 106 before using it as input to a following layer.

In an example, layer 100 can be divided into smaller units. Each unit can separately use a length of a pre-normalized activity vector to discriminate between positive inputs 102 and negative inputs 114.

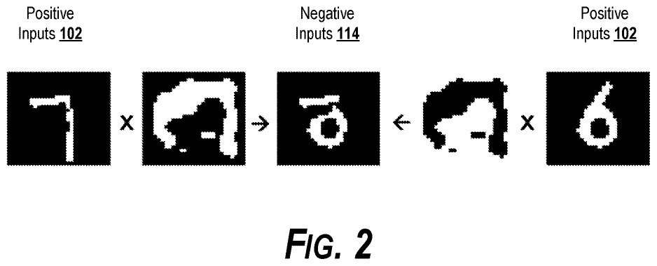

FIG. 2 is an illustration of an example technique for generating negative inputs 114. Two positive inputs 102 are shown: an image of the numeral “7” and an image of the numeral “6.” A hybrid image can be generated from the two. For instance, negative data that has very different long range correlations but very similar short range correlations can cause the model being trained to focus on the longer range correlations. In an image processing example, this can be done by creating a mask containing fairly large regions of ones and zeros. Hybrid images can then be created for the negative data by adding together one digit image times the mask and a different digit image times the reverse of the mask. Masks like this can be created by starting with a random bit image and then repeatedly blurring the image with a filter (e.g., a filter of the form [¼, ½, ¼]) in both the horizontal and vertical directions. After repeated blurring, the image can then be thresholded (e.g., at 0.5).

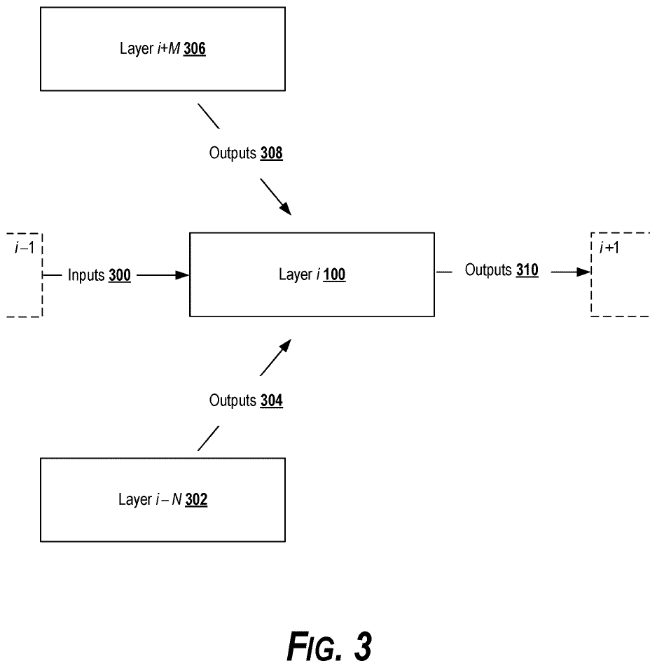

FIG. 3 is a block diagram of an example system for sharing learning across layers/feature levels of a machine-learned model. A layer 100 (e.g., a layer i) which processes inputs 300 can also receive, from another layer 302 that can precede layer 100 in the architecture (e.g., a layer i−N, where N∈ [symbol] ), outputs 304 from that layer. Layer 100 can also receive, from another layer 306 that can follow layer 100 in the architecture (e.g., a layer i+M, where M∈ [symbol] ), outputs 308 from that layer. Layer 100 can ingest outputs 304 and 308 to generate outputs 310.

Signals received from layer(s) 306 can be from a same or previous forward pass. For example, when the machine-learned model processes a time series, it can process steps of the time series in different respective forward passes. Signals from layer(s) of the model in a previous forward pass can inform the processing of the same or different layers in a subsequent forward pass. During the same forward pass, different towers or processing paths of the machine-learned model can contain cross-connections that share latent states between the towers. For example, layer 306 can be in a different processing path than layer 100, such that layer 306 does not strictly precede layer 100 but can still inform the processing of layer 100.

Signals received from layer(s) 302 can be from a same or previous forward path.

An objective can be to have good agreement between the input from a layer above and input from a layer below for positive data and bad agreement for negative data. In a network with spatially local connectivity, this can have a desirable property: The top-down input (e.g., from a layer or higher level layer) can be determined by a larger region of the image and can be the result of more stages of processing so it can be viewed as a contextual prediction for what should be produced by the bottom-up input which can be based on a more local region of the image. If the input is changing over time, the top-down input can be based on older input data so it can learn to predict the representations of the bottom-up input. For an objective function which aims for low squared activities for positive data, the top-down input can learn to cancel out the bottom-up input on positive data. The layer normalization can facilitate information to be sent to the next layer even when the cancelation works well. Small prediction errors can be exaggerated by the normalization thus making them more resistant to noise in transmission.

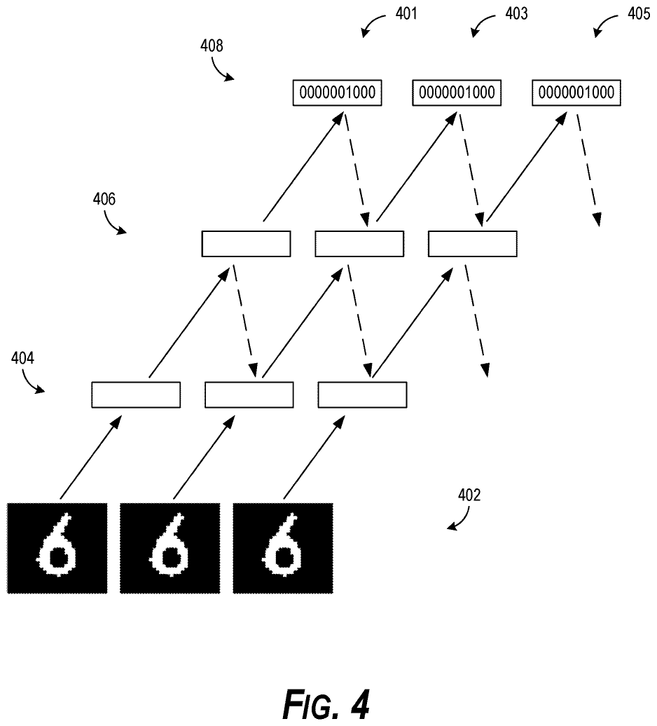

FIG. 4 is an example implementation of sharing learning across layers. In an example, an input image 402 of the numeral “6” can be treated as a “video” over multiple time steps. The network can run forwards in time for both the positive and negative data. For example, an input 402 for processing step 401 can pass through layers 404 and 406 to obtain a classification vector output 408 (e.g., one-of-N representation of the digit class). The activity vector at each layer can be determined by the normalized activity vectors at both the layer above and the layer below at the previous time-step. For example, layer 406 at time 403 can receive inputs from output layer 408 at time 401. Layer 404 at time 405 can receive inputs from layer 406 at time 403.

Example results are provided herein for the sake of illustration only. As a baseline, MNIST classification tests are used. 50,000 of the official training images are used for training and 10,000 for validation during the search for good hyper-parameters. The official test set of 10,000 images is then used to compute the test error rate. Sensibly-engineered convolutional neural nets with a few hidden layers typically get about 0.6% test error on the test set of MNIST.

In the “permutation-invariant” version of the task, the neural net is not given any information about the spatial layout of the pixels so it would perform equally well if all of the training and test images were subjected to the same random permutation of the pixels before training started. For the permutation-invariant version of the task, feed-forward neural networks with a few fully connected hidden layers of Rectified Linear Units (ReLUs) typically get about 1.4% test error and they take about 20 epochs to train. This can be reduced to around 1.1% test error using a variety of regularizers such as dropout (which makes training slower) or label smoothing (which makes training faster). It can be further reduced by combining supervised learning of the labels with unsupervised learning that models the distribution of images. To summarize, achieving 1.4% test error on the permutation-invariant version of the task without using complicated regularizers, shows that, for MNIST, a given learning procedure works about as well as backpropagation.

For an unsupervised forward-forward implementation that uses hybrid inputs generated in the manner illustrated in FIG. 2, after training a network with four hidden layers of 2000 ReLUs each for 100 epochs, a test error rate of 1.37% was achieved if normalized activity vectors of the last three hidden layers were used as the inputs to a softmax that is trained to predict the label. Using the first hidden layer as part of the input to the linear classifier made the test performance worse in this example.

Instead of using fully connected layers, local receptive fields (without weight-sharing) can be used. In another test, this improved the performance. The architecture used for this additional test is as follows: The first hidden layer used a 4×4 grid of locations with a stride of 6, a receptive field of 10×10 pixels and 128 channels at each location. The second hidden layer used a 3×3 grid with 220 channels at each grid point. The receptive field was all the channels in a square of 4 adjacent grid points in the layer below. The third hidden layer used a 2×2 grid with 512 channels and, again, the receptive field was all the channels in a square of 4 adjacent grid points in the layer below. This architecture has approximately 2000 hidden units per layer. After training for 60 epochs it gave 1.16% test error. It used “peer normalization” of the hidden activities to prevent any of the hidden units from being extremely active or permanently off.

For a supervised forward-forward implementation that used the first 10 pixels of the image (in a blank border) to store a one of N representation of the label, a network with 4 hidden layers each containing 2000 ReLUs and full connectivity between layers gets 1.36% test errors on MNIST after 60 epochs. Backpropagation takes about 20 epochs to get similar test performance. Doubling the learning rate of FF and training for 40 epochs instead of 60 gives a slightly worse test error of 1.46% instead of 1.36%.

In another test, the training data was augmented by jittering the images by up to two pixels in each direction to get 25 different shifts for each image. This uses knowledge of the spatial layout of the pixels so it is no longer permutation invariant. Training the same net for 500 epochs with this augmented data results in 0.64% test error which is similar to a convolutional neural net trained with backpropagation.

For an implementation that leverages top-down information sharing, a test was conducted that used “video” input that consisted of a static MNIST image which is simply repeated for each time-frame. The bottom layer is the pixel image and the top layer is a one-of-N representation of the digit class. There are two or three intermediate layers each of which has 2000 neurons. In a preliminary experiment, the recurrent net was run for 10 time-steps and at each time-step the even layers were updated based on the normalized activities in the odd layers and then the odd layers were updated based on the new normalized activities in the even layers. This alternating update was designed to avoid biphasic oscillations, but it can be unnecessary. Synchronous updates of all hidden layers based on the normalized states at the previous time step can be used (e.g., with some damping). Synchronous updates can learn better for some architectures (e.g., less regular architectures). During the test, then, synchronous updates are used with the new pre-normalized states being set to 0.3 of the previous pre-normalized state plus 0.7 of the computed new state. The net shown in FIG. 4 was trained on MNIST for 60 epochs. For each image, the hidden layers are initialized by a single bottom-up pass. After this the network is run for 8 synchronous iterations with damping. The performance of the network on the test data is evaluated by running it for 8 iterations with each of the 10 labels and picking the label that has the highest goodness averaged over iterations 3 to 5. The test resulted in 1.31% test error. Negative data is generated by doing a single forward pass through the net to get probabilities for all the classes and then choosing between the incorrect classes in proportion to their probabilities.

Further test results are provided using CIFAR-10. CIFAR-10 (Krizhevsky and Hinton, 2009) has 50,000 training images that are 32×32 with three color channels for each pixel. Each image, therefore, has 3072 dimensions. The images have complicated backgrounds that are highly variable and cannot be modeled well given such limited training data. A fully connected net with two or three hidden layers can overfit badly when trained with backpropagation unless the hidden layers are very small, so nearly all of the reported results are for convolutional nets.

Forward-forward training here is compared with a backpropagation net that used local receptive fields to limit the number of weights without seriously restricting the number of hidden units. Such an experiment can test the hypothesis that with sufficient numbers of hidden units, forward-forward training can be comparable in performance to backpropagation for images that contain highly variable backgrounds.

The networks for this test contained two or three hidden layers of 3072 ReLUs each. Each hidden layer is a 32×32 topographic map with 3 hidden units at each location. Each hidden unit has an 11×11 receptive field in the layer below so it has 363 bottom-up inputs. (For hidden neurons near the edge of the map the receptive field is truncated at the edge of the image.) For the forward-forward trained networks, hidden units in the last hidden layer have 10 top-down inputs and in other layers they have up to 363 top-down inputs from an 11×11 receptive field in the layer above. One way to implement this connectivity on a GPU is to learn with full connectivity but to use a precomputed mask to reset all of the non-existent weights to zero after each weight update.

Table 1 shows the test performance of networks trained with backpropagation (BP) and forward-forward training (FF), with both methods using weight-decay to reduce overfitting. To test a net trained with FF, the tests used either use a single forward pass to obtain a softmax over the classification vector (One-Pass Softmax) or the network ran for 10 iterations with the image and each of the 10 labels and the energy for a label was accumulated over iterations 4 to 6 when the goodness-based error was the lowest (Accumulated Goodness). Notably, for a large number of labels, a single forward pass can be used to get a candidate list of which labels to evaluate more thoroughly using an accumulated goodness approach.

Notably, although the test performance of FF can be worse than backpropagation in this test, it is only slightly worse, even when there are complicated confounding backgrounds. The gap between the two procedures did not increase with more hidden layers.

TABLE 1
Comparing backpropagation and forward-
forward training on CIFAR-10.

| Learning | Testing | Hidden | Training | Test |
|---|---|---|---|---|
| Procedure | Procedure | Layers | Error (%) | Error (%) |
| BP | — | 2 | 0 | 37 |
| | | 3 | 2 | 39 |
| FF min ssq | Accumulated | 2 | 20 | 41 |
| | Goodness | 3 | 24 | 41 |
| | One-Pass | 2 | 31 | 45 |
| | Softmax | 3 | 32 | 44 |
| FF max ssq | Accumulated | 2 | 25 | 44 |
| | Goodness | 3 | 21 | 44 |
| | One-Pass | 2 | 33 | 46 |
| | Softmax | 3 | 31 | 46 |

Therefore, the results suggest that with sufficient numbers of hidden units, forward-forward training can be comparable in performance to backpropagation for images that contain highly variable backgrounds. This suggests that forward-forward training can obtain the advantages described herein with little to no performance penalty, in some implementations.

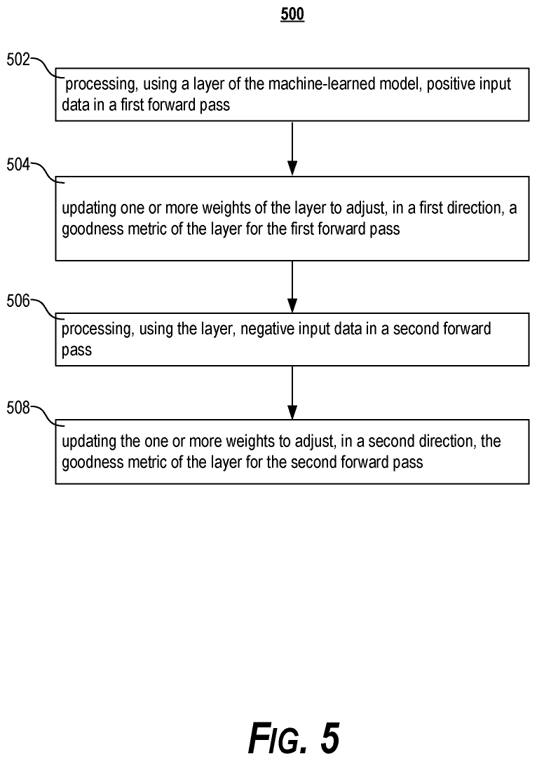

FIG. 5 depicts a flowchart of a method 500 for training one or more machine-learned models according to aspects of the present disclosure. One or more portion(s) of example method 500 can be implemented by a computing system that includes one or more computing devices such as, for example, computing systems described with reference to the other figures. Each respective portion of example method 500 can be performed by any (or any combination) of one or more computing devices. Moreover, one or more portion(s) of example method 500 can be implemented on the hardware components of the device(s) described herein, for example, to train one or more systems or models. FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 5 is described with reference to elements/terms described with respect to other systems and figures for exemplary illustrated purposes and is not meant to be limiting. One or more portions of example method 500 can be performed additionally, or alternatively, by other systems.

At 502, example method 500 can include processing, using a layer of the machine-learned model, positive input data in a first forward pass. For example, positive input data to a layer can include positive inputs 102 to layer 100. A first forward pass for an example machine-learned model is illustrated in FIG. 1A. In some implementations of example method 500, the positive input data includes image data.

At 504, example method 500 can include updating one or more weights of the layer to adjust, in a first direction, a goodness metric of the layer for the first forward pass. For example, weight updates 112 can be applied to weights 104 to cause layer 100 to increase or decrease a value of the goodness metric. In some implementations of example method 500, the goodness metric is a local goodness metric for evaluating the layer. In some implementations of example method 500, the goodness metric is based on the activations in the layer (e.g., based on a quantity or magnitude of activations in the layer).

At 506, example method 500 can include processing, using the layer, negative input data in a second forward pass. For example, negative input data to the layer can include negative inputs 114 to layer 110. A second forward pass for an example machine-learned model is illustrated in FIG. 1B. In some implementations of example method 500, the negative input data includes a contrastive example to the positive input data.

At 508, example method 500 can include updating the one or more weights to adjust, in a second direction, the goodness metric of the layer for the second forward pass. For example, weight updates 120 can be applied to weights 104 to cause layer 100 to increase or decrease a value of the goodness metric.

For example, weight updates 112 can adjust weights 104 to increase the goodness metric over layer 100 evaluated for positive inputs 102 and weight updates 120 can adjust weights 104 to decrease the goodness metric over layer 100 evaluated for negative inputs 114.

For example, weight updates 112 can adjust weights 104 to decrease the goodness metric over layer 100 evaluated for positive inputs 102 and weight updates 120 can adjust weights 104 to increase the goodness metric over layer 100 evaluated for negative inputs 114.

In some implementations of example method 500, updating the weights to adjust the goodness metric in the first direction includes updating the weights to increase activations in the layer for positive input data. In some implementations of example method 500, updating the weights to adjust the goodness metric in the second direction includes updating the weights to decrease activations in the layer for negative input data.

In some implementations of example method 500, updating the weights to adjust the goodness metric in the first direction includes updating the weights to decrease activations in the layer for positive input data. In some implementations of example method 500, updating the weights to adjust the goodness metric in the second direction includes updating the weights to increase activations in the layer for negative input data.

In some implementations of example method 500, the negative input data is generated using the machine-learned model. For example, the negative input data can be a hard negative input selected using a known performance of the model (e.g., an output distribution from a prior forward pass). Other machine-learned models can generate negative inputs configured to increase a margin around a decision boundary (e.g., analogous to the widest street of a support vector machine).

In some implementations of example method 500, the positive input data includes image data. In some implementations of example method 500, the negative input data is generated by masking the positive input data. This can be done by creating a mask containing regions of ones and zeros. Hybrid images can then be created for the negative data by adding together one digit image times the mask and a different digit image times a different mask (e.g., the reverse of the mask). Masks like this can be created by starting with a random bit image and then repeatedly blurring the image with a filter.

In some implementations of example method 500, example method 500 includes, for each respective forward pass, postprocessing the output of the layer to obscure, from a subsequent layer, the goodness metric of the layer. In some implementations of example method 500, the postprocessing includes normalizing the output of the layer. For example, if the activities of a layer are then used as input to a second layer, the second might “cheat” and distinguish positive from negative data by simply using the length of activity vector from the first layer. Example implementations of the present disclosure can normalize the length of the hidden vector before using it as input to a following layer. In some aspects, this can remove information that was used to determine the goodness in the first layer and force the next layer to infer the positive or negative attribute using information in the relative activities of the neurons in the first layer. These relative activities can be preserved in the layer-normalization. The activity vector in the first layer can have a length and an orientation. The length can be used to define the goodness for that layer. The orientation can be passed to the next layer (e.g., only the orientation).

In some implementations of example method 500, the positive input data includes a ground truth label and the negative input data comprises an incorrect label. In an image processing example, the positive data can include an image with the correct label and the negative data can include the image with the incorrect label. In an example, the only difference between positive and negative data is the label. After training, it can be possible to classify an input image by doing a single forward pass through the net starting from an input that consists of the image and a neutral label composed of a uniform distribution over output classes (e.g., classification categories). The hidden activities of one or more layers (e.g., all but the first hidden layer) can then be used as the inputs to a softmax that has been learned during training.

The network can be executed with a particular label as part of the input. The goodnesses of one or more layers (e.g., all but the first) can be accumulated. After doing this for each label separately, the label with the highest accumulated goodness can be selected as the output. During training, a forward pass from a neutral label can be used to pick hard negative labels.

In some implementations of example method 500, example method 500 includes identifying top-K output classes using single passes (e.g., one-pass softmax) and then using the accumulated goodness approach to refine the outputs for the top-K output classes. For instance, an ultimate output class can be selected based on comparing the accumulated goodnesses for each of the top-K labels.

In some implementations of example method 500, example method 500 includes processing a test input with a neutral label. In some implementations of example method 500, example method 500 includes computing a softmax over activations within one or more layers of the machine-learned model. In some implementations of example method 500, example method 500 includes returning an output of the machine-learned model based on an output of the softmax. In some implementations of example method 500, the output of the softmax is a prediction output. In some implementations of example method 500, the neutral label includes a uniform distribution over prediction classes.

In some implementations of example method 500, the machine-learned model includes a non-differentiable component. For example, the machine-learned model can include one or more “black box” components that do not admit gradients to pass through them for backpropagation.

In some implementations of example method 500, the layer receives a top-down input from another layer ordered subsequent to the layer. In some implementations of example method 500, the layer receives a top-down input associated with a prior forward pass.

In some implementations of example method 500, the machine-learned model includes a fast training loop and a slow training loop. In some implementations of example method 500, the layer is in the fast training loop and the slow training loop includes one or more other machine-learned components. In some implementations of example method 500, the slow training loop operates over a longer time scale than the fast training loop. For example, forward-forward training can operate on networks that include unknown “black box” components. The black box can apply an unknown and possibly stochastic transformation to the output of one layer and presents this transformed activity vector as the input to the next layer. This does not disturb or prevent the local learning within each layer.

In an example, the black boxes can be or include machine-learned components (e.g., neural nets with a few hidden layers). If these machine-learned components learn slowly with respect to the non-black box components (e.g., the “outer loop”), then the “outer loop” forward-forward learning can quickly adapt to new data under the assumption that the black boxes are stationary. Slow learning in the black boxes can then improve the system over a much longer timescale. For example, a slow reinforcement learning procedure could add small random noise vectors to the inputs to neurons inside the black box and then multiply these activity perturbation vectors by the change in the cost function used by the positive phase of the forward-forward training system to get a noisy but unbiased estimate of the derivative of the forward-forward cost function with respect to the activities of neurons inside the black box.

In some implementations, example method 500 can train an analog neural network. For example, analog neural networks can use electrical properties, such as voltage, current, and conductance, to facilitate computations instead of or in addition to using digital logic or operations. The networks can use analog signals to represent data and perform computations by transforming signals in the analog domain. This can result in more efficient power usage and faster processing times.

For example, in an analog neural network, a ‘neuron’ or other processing unit can be a circuit where the input or output is an analog signal. Voltage sources can provide an input signal to the processing unit. The conductance between processing units can act as a weight on a connection between processing units: the higher the conductance, the greater the effect of the processing unit on a connected processing unit. The current induced by the voltage source over the conductive element can create a voltage drop across the resistance (inverse of conductance), which can be an input to the next processing unit.

Nonlinear activations can also be obtained using circuit components with nonlinear characteristics, such as diodes or transistors, which can have nonlinear voltage-current characteristics. For example, diodes can be configured with different orientations (e.g., orientation of anode and cathode) and bias voltages (e.g., to shift the saturation point, shaping the nonlinearity).

Training the analog neural network can include initialing values of the ANN (e.g., voltage sources, resistance values, etc.) and iteratively adjusting the values to improve an objective metric. The ANN can be initialized by simulating the ANN (e.g., in a circuit simulator) and pre-training the ANN in simulation. If differentiable circuit models are used in simulation, the pre-training can be performed with backpropagation through the simulated ANN.

The results of the pre-training can be used to initialize a physical ANN. The physical ANN can then be further trained/refined using forward-forward training to adapt to the actual hardware components used in the physical ANN (which can have variable characteristics due to manufacturing tolerances). The results of the pre-training can be used to initialize a plurality of different physical instances of the same ANN. Each physical instance can be separately trained and can converge to different final configurations based on the different actual characteristics of the circuit components. Advantageously, training according to example method 500 can provide for training ANNs without a physical implementation of backpropagation.

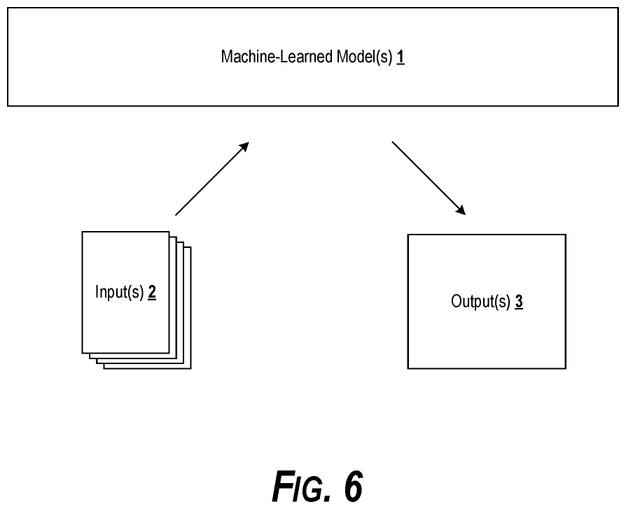

FIG. 6 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

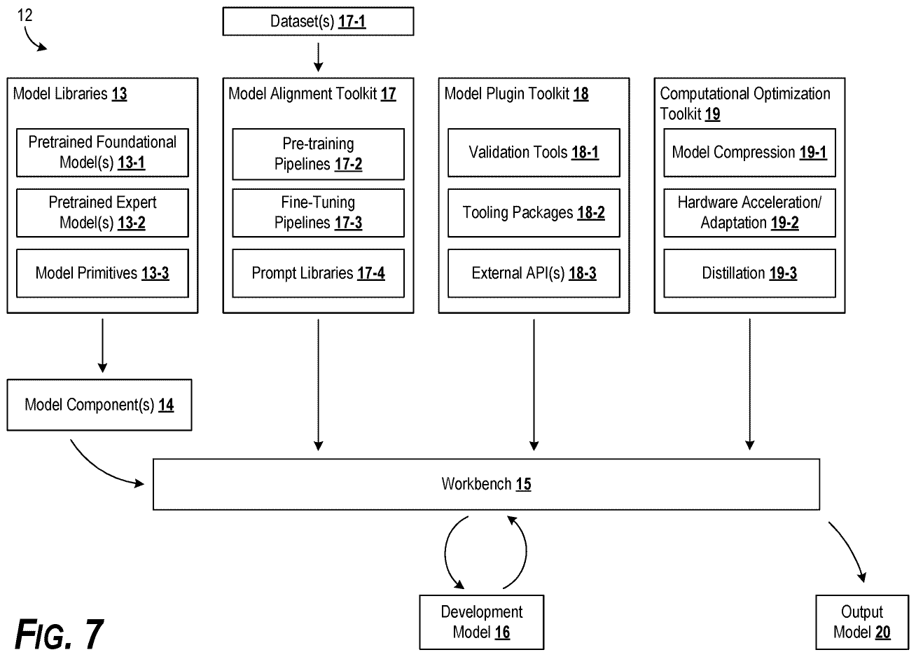

FIG. 7 is a block diagram of an example model development platform 12 that can facilitate creation, adaptation, and refinement of example machine-learned models (e.g., machine-learned model(s) 1, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. This can include training a machine-learned model using a forward-forward training approach as described herein.

Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 500 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

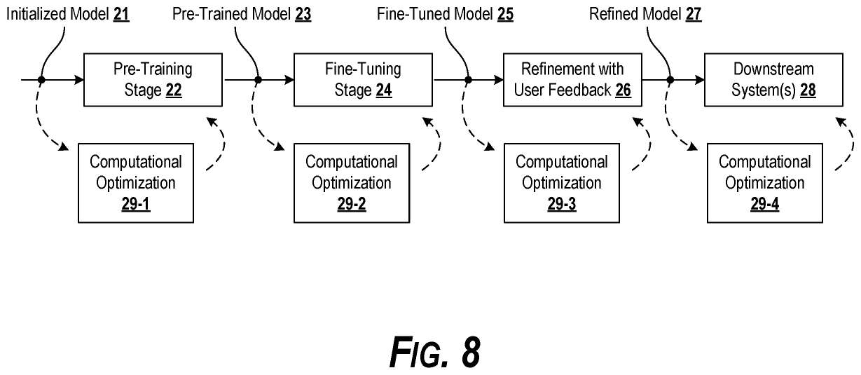

FIG. 8 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 8 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

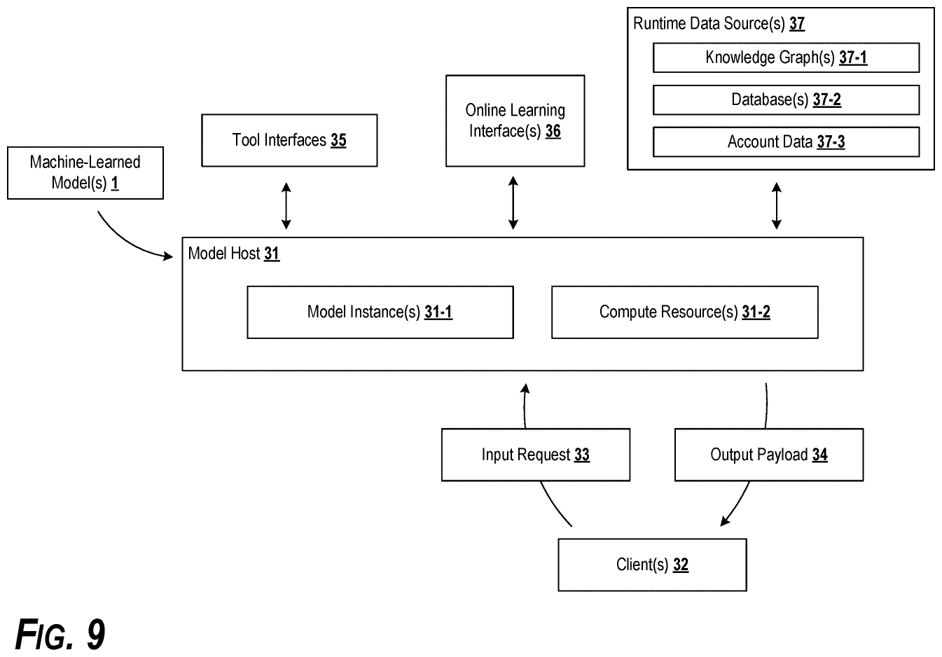

FIG. 9 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

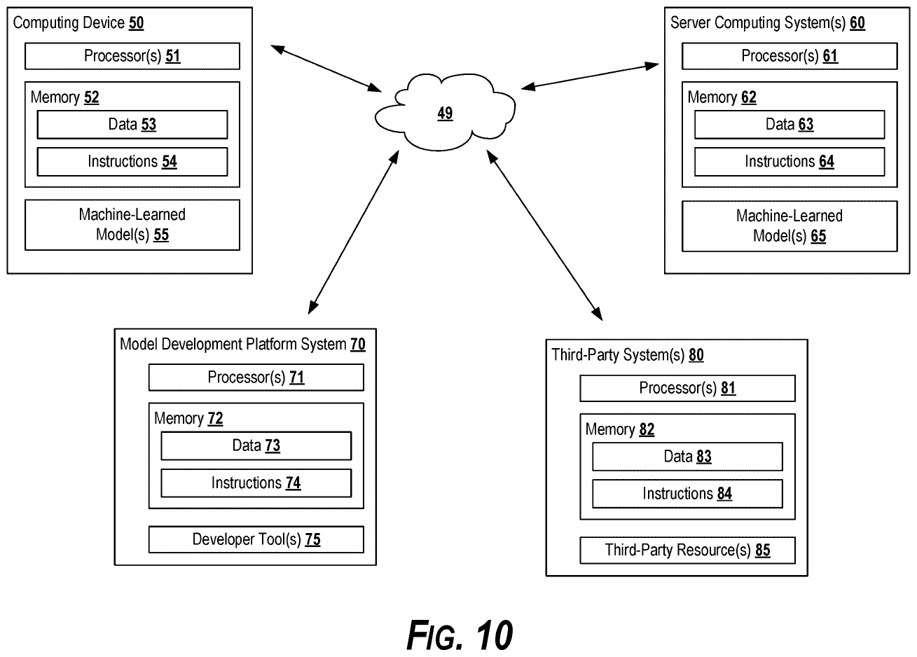

FIG. 10 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 10 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model, a CNN, etc. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model, a CNN, etc. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 10 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

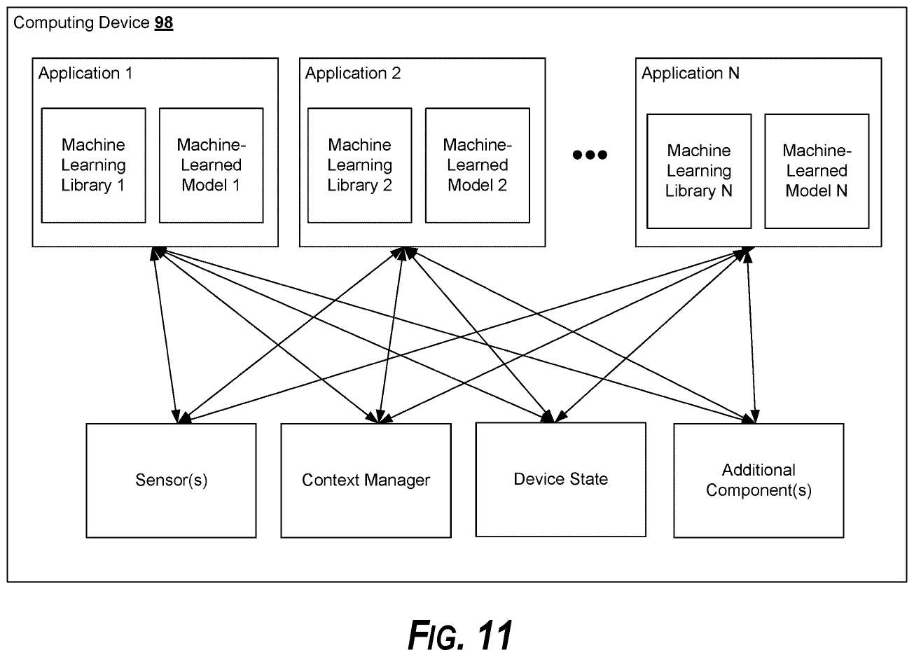

FIG. 11 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 11, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

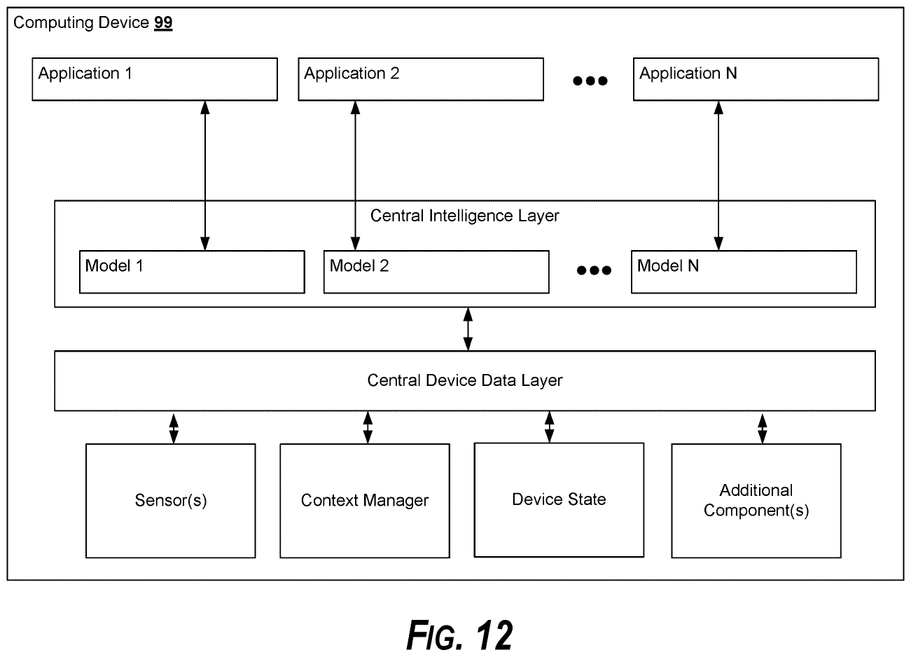

FIG. 12 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 12, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 12, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

1. A computer-implemented method for training a machine-learned model, the method comprising:
processing, using a layer of the machine-learned model, positive input data in a first forward pass;
updating one or more weights of the layer to adjust, in a first direction, a goodness metric of the layer for the first forward pass;
processing, using the layer, negative input data in a second forward pass; and
updating the one or more weights to adjust, in a second direction, the goodness metric of the layer for the second forward pass.

2. The computer-implemented method of claim 1, wherein the negative input data is generated using the machine-learned model.

3. The computer-implemented method of claim 1, wherein the positive input data comprises image data, and wherein the negative input data is generated by masking the positive input data.

4. The computer-implemented method of claim 1, wherein the negative input data comprises a contrastive example to the positive input data.

5. The computer-implemented method of claim 1, comprising:
for each respective forward pass, postprocessing the output of the layer to obscure, from a subsequent layer, the goodness metric of the layer.

6. The computer-implemented method of claim 1, wherein the postprocessing comprises normalizing the output of the layer.

7. The computer-implemented method of claim 1, wherein the goodness metric is a local goodness metric for evaluating the layer.

8. The computer-implemented method of claim 7, wherein the goodness metric is based on the activations in the layer.

9. The computer-implemented method of claim 8, wherein updating the weights to adjust the goodness metric in the first direction comprises updating the weights to increase activations in the layer for positive input data.

10. The computer-implemented method of claim 8, wherein updating the weights to adjust the goodness metric in the second direction comprises updating the weights to decrease activations in the layer for negative input data.

11. The computer-implemented method of claim 1, wherein the positive input data comprises a ground truth label and the negative input data comprises an incorrect label.

12. The computer-implemented method of claim 1, comprising:
processing a test input with a neutral label;
computing a softmax over activations within one or more layers of the machine-learned model; and
returning an output of the machine-learned model based on an output of the softmax.

13. The computer-implemented method of claim 12, wherein the output of the softmax is a prediction output.

14. The computer-implemented method of claim 12, wherein the neutral label comprises a uniform distribution over prediction classes.

15. (canceled)

16. The computer-implemented method of claim 1, wherein the machine-learned model comprises a non-differentiable component.

17. The computer-implemented method of claim 1, wherein the layer receives a top-down input from another layer ordered subsequent to the layer.

18. The computer-implemented method of claim 1, wherein the layer receives a top-down input associated with a prior forward pass.

19. The computer-implemented method of claim 1, wherein the machine-learned model comprises a fast training loop and a slow training loop, wherein the layer is in the fast training loop and the slow training loop comprises one or more other machine-learned components, wherein the slow training loop operates over a longer time scale than the fast training loop.

20. One or more non-transitory computer-readable media storing instructions that are executable by one or more processors to perform operations, the operations comprising:
processing, using a layer of the machine-learned model, positive input data in a first forward pass;
updating one or more weights of the layer to adjust, in a first direction, a goodness metric of the layer for the first forward pass;
processing, using the layer, negative input data in a second forward pass; and
updating the one or more weights to adjust, in a second direction, the goodness metric of the layer for the second forward pass.

21. A computing system comprising:
one or more processors; and
one or more non-transitory computer-readable media storing instructions that are executable by the one or more processors to cause the computing system to perform operations, the operations comprising:
processing, using a layer of the machine-learned model, positive input data in a first forward pass;
updating one or more weights of the layer to adjust, in a first direction, a goodness metric of the layer for the first forward pass;
processing, using the layer, negative input data in a second forward pass; and
updating the one or more weights to adjust, in a second direction, the goodness metric of the layer for the second forward pass.

22. (canceled)
